(19) United States
(12) Patent Application Publication
(10) Pub. No.: US 2019/0329953 A1
(43) Pub. Date: Oct. 31, 2019

(54) Receptacle

(71) Applicant: Ezypro10.com, Frederiksberg (DK)

(72) Inventor: Lincoln AWADA, Kobenhavn V (DK)

(21) Appl. No.: 16/471,528

(22) PCT Filed: Dec. 23, 2016
(86) PCT No.: PCT/DK2016/050469

§ 371 Date: Jun. 19, 2019

(51) Int. Cl. B65D 75/58; B65D 85/816; B01F 1/00; B01F 13/00

(52) U.S. Cl. CPC B65D 75/5883; B65D 85/816; B01F 2215/0022; B01F 13/0022; B01F 2001/0088; B01F 1/0016

(57) ABSTRACT

A receptacle for containing a powder and for mixing the powder with a liquid into a mixed product. The receptacle comprises a body at least partly comprising a flexible material, the body being adapted to be collapsible when containing the powder and to be expandable when receiving the liquid, a conduit being connected to the body and comprising a first and a second open end, where the first open end is arranged outside the body and the second open end is arranged in the inner volume of the body so that the conduit provides fluid communication between the outside and the inner volume of the body, the first open end being releasably connected to a closing member for blocking access through the first open end, the the receptacle further comprising a filter element adapted to be connected to the second open end of the conduit.

### FIELD OF THE INVENTION

The present invention relates to a receptacle for containing a powder and for mixing said powder with a liquid into a mixed product.

### DESCRIPTION OF PRIOR ART

The increasing focus on good health and physical activity results in a need for food products targeted against weight loss, muscle gain, etc. Of particular interest is food products that are easily prepared and consumed without need of further handling. Such products may be in the form of a liquid containing the sufficient nutrients, such as nutrients supplied in powder form and mixed with water or other consumable liquids.

Known products for mixing consumable powders with consumable liquids include drinking bottles, and subcategories such as blender bottles or shaking bottles, pouches containing a premixed liquid, or pouches containing a nutrient and being prepared receiving a liquid.

Known drinking bottles are not efficient to use in case a liquid has to be mixed with a powder substance as the bottle has to be shaken for a long time to avoid some of the powder not being dissolved. Undissolved powder will bring discomfort in drinking the mixed product or may clog the opening of the drinking bottle.

Blender bottles are targeted the problem of mixing a powdered substance with a liquid. The appearance is similar to ordinary drinking bottles, but is further equipped with a solid element adapted to move freely within the bottle, when said bottle is closed. When needed, the user fills the bottle with the desired amount of powder and liquid and shakes the bottle such that the solid element whisks the mix. The solid element may have elastic properties (e.g. a metal spring) for better movement.

Shaking bottles are another type of bottles targeted the problem of mixing a powdered substance with a liquid. In a shaker bottle, a coarse-meshed mesh is provided within the bottle, such that the liquid is forced to move through mesh, thereby breaking apart lumps of powder. The mesh is coarse for enabling easy shaking and movement of the liquid through said mesh.

Pouches prefilled with a nutritious liquid is an option when the bulky drinking bottles are not an option. This could be the case in endurance running, where the product has to be easily stored in e.g. a pocket or in a belt.

Pouches prefilled with a nutritious powder and prepared to be manually filled with a liquid by the user are known as well. Here, a conduit allows the user to add e.g. water and subsequently consume the mix.

Thus, known bottles for mixing a powder with a liquid requires a long-lasting mixing process and undissolved powder will bring discomfort in drinking the mixed product or may clog the opening of the drinking bottle.

### SUMMARY OF THE INVENTION

In accordance with the invention, a receptacle is provided for containing a powder and for mixing said powder with a liquid into a mixed product, the receptacle comprising
a body at least partly comprising a flexible material, said body being of a type that is at least adapted to be collapsible when containing the powder and to be expandable when receiving the liquid,
a conduit being connected to said body and comprising a first and a second open end, where said first open end is arranged outside said body and said second open end is arranged in the inner volume of said body so that the conduit provides fluid communication between the outside and the inner volume of said body, and where said first open end is releasably connected to a closing member for blocking access through said first open end,
where the receptacle further comprises a filter element adapted to be connected to said second open end of the conduit.

Providing a filter element, which may be connected to the second open end of the conduit, ensures that clots of not-dissolved powder remaining after the mixing of powder and liquid is not consumed by the user, but allows the liquid to be introduced into the receptacle. This increases the smoothness and tasting experience of the mixed product. The mixing of the powder and liquid may be carried out by shaking the receptacle.

Within the present application, a liquid may be understood as a consumable liquid, which may be any liquid being safe for humans to consume. Examples include water, milk, or fruit juices.

Within the present application, a powder may be understood as a consumable powder, which may be any powder being safe for humans to consume. The powder may be a protein source such as whey protein powder, soy protein powder, or beef protein powder.

The invention is not limited to powders. The powder may be substituted by pellets or pills capable of dissolving in a liquid.

Additional ingredients may be included in powder or pellet form. Examples include, but are not limited to, flavouring, colouring, vitamins, glutamine, creatine, carbohydrates, or mixing agents such as emulsifiers.

The protein source is most preferably added to the receptacle during manufacturing. The amount of protein may depend on the size of the receptacle and recommendations set out by authorities for daily needs. The amount may be below 10 grams, or below 20 grams, or below 30 grams, or below 40 grams, or below 50 grams.

In an embodiment, the filter element can be adapted to be releasably connected to the second open end of the conduit.

Thereby, the user has the possibility of either using the filter element or not. The filter element may also be replaced if it is broken or deformed, which may e.g. happen during packing or transportation. Further, the user may remove the filter element, if the user wants to use the powder in e.g. a glass instead of in the receptacle. By allowing the filter elements to be removed, the filter element may be reused in another receptacle.

In an embodiment, the filter element can be adapted to be connected to the second open end of the conduit by being adapted to be inserted through the first open end and moved to the second open end of the conduit.

The conduit may be the only opening of the receptacle. Thus, advantageously, the filter element may be inserted through the first opening of the conduit. The filter element may protrude into the inner volume of said body, when it is connected to the second open end of the conduit. Thereby, the user may remove the filter element again by pressing the tip/end/vertex of the filter element at the second open end of the conduit in a direction towards the first open end of the conduit. The user may press the tip/end/vertex of the filter element by deforming/manipulating the flexible material of the body of the receptacle.

In an embodiment, the filter element and/or the conduit can comprise a rigid material. In an embodiment, the rigid material can be a plastic material such as polyethylene (PE), polyethylene terephthalate (PET), polystyrene (PS), and polypropylene (PP), or combinations thereof.

Thereby, the filter element is not damaged or deformed upon transport, packaging, handling, or during the mixing procedure. Further, a rigid material provides an improved whisking effect and thereby a better mixing of the powder with the liquid. Further, by providing a filter element of a rigid material, the size and distribution of the at least one pore of the filter element is maintained.

In an embodiment, the filter element can comprise an elongated shape.

In an embodiment, the length of the filter element can be at least equal to a diameter of the conduit, or said length can be at least 2 times said diameter, or said length can be at least 3 times said diameter.

By providing a filter element comprising an elongated shape, the filter element may assist the mixing procedure by providing a whisking effect when the receptacle is shaken by the user, as liquid and powder are spread out/scattered when colliding with the filter element. Further, the risk of powder escaping a receptacle without a closing member before liquid is introduced into the receptacle, is reduced as the filter element deflects the powder, which is then forced away from rather than through the conduit.

In an embodiment, the filter element can comprise a hollow structure.

In an embodiment, the filter element can comprise a hollow cylinder. Thereby, the total weight of the receptacle is minimised.

In an embodiment, the hollow structure of the filter element can be at least partly conically shaped. The conically shaped hollow structure may further be a truncated conically shaped hollow structure. A conical shape may facilitate that the liquid and powder spread out/scatter when colliding with the filter element during a shaking of the receptacle.

The filter element may comprise alternative three-dimensional structures comprising a predominantly longitudinal shape, such as elongated polyhedrons.

Thereby, by the above embodiments, a filter element is obtained, which is capable of protruding into the inner volume of the body.

In an embodiment, the filter element can comprise a ring base for attachment to the second open end of the conduit.

The ring base may define one end of the filter element for attachment to the second open end of the conduit by an attachment means. The attachment means may comprise e.g. adhesives, an engagement or friction fit. Thereby, liquid can flow through the base, through the hollow filter element and through the at least one pore in the surface of said filter element.

In an embodiment, the filter element can comprise at least one filtering pore, thereby providing fluid communication between the outside and the inner volume of said body, when said filter element is attached to the second open end of the conduit.

Thereby, consumable liquid may be added to the inner volume of the receptacle, and the mix of consumable powder with said consumable liquid may escape the inner volume of the body. However, undissolved powder in the form of clots may not escape the inner volume of the body.

In an embodiment, the filter element can comprise at least a first and a second filtering pore, where the first filtering pore can be arranged closer than the second filtering pore to the second open end of the conduit, when the filter element is connected to said second open end of the conduit, and where the diameter of the first filtering pore can be less than the diameter of the second filtering pore.

The applicant has found that undissolved powder (clots) may inter alia be arranged at an inner surface of the top and bottom part of the body of the receptacle relative a longitudinal axis of the said body (and receptacle), if shaking the receptacle along said longitudinal axis. If the second end of the conduit comprising the filter element is arranged at said top or bottom part of the body, then a first filtering pore arranged closer to the second opened end of the conduit, and therefore to the inner surface of top or bottom part of the body, than a second filtering pore is exposed more to the undissolved powder. Therefore, the diameter of said first filtering pore is advantageously less than the diameter of said second filtering pore, so that the risk of undissolved powder flowing out of the receptacle is minimised.

In an embodiment, the filter element can comprise a vertex being either truncated or pointed.

By a vertex is meant the tip of the conically shaped structure. The vertex may either be pointed or may be truncated and may thereby form a truncated conically shaped structure. The vertex may be open or closed and may have a diameter/cross-sectional area being smaller than the diameter/cross-sectional area of the base (e.g. ring base) of the filter element, which base may be attached to the second open end of the conduit.

Thereby, the filter element deflects the liquid during shaking of the receptacle, thereby preventing clotting of the pores of the filter element by the powder. Further, in case the vertex is open, and possibly have a diameter being larger than the diameter of the at least one filtering pore of the filter, liquid is introduced into the inner volume of the body at a higher flow rate.

In an embodiment, the maximum diameter of the at least one pore can be smaller than 2 mm, or 1.5 mm, or 1 mm, or 0.5 mm. By a pore is meant an opening in the surface of the filter element providing access between the inner volume of the body and the second open end of the conduit. The at least one pore may be a circular hole, but polygons are foreseen as well. In the case of polygons, the maximum diameter is the longest diagonal within the polygon.

Thereby, the filtering capabilities may be adjusted to fit specific powders or needs. Further, the size of the at least one pore determines the maximum size of clots the consumer may experience upon consumption of the mixed product, in a case where the vertex of the filter element is closed. Further, the size of the at least one pore determines the size of non-dissolved additives, such as chocolate, which may be added to the powder to increase the tasting experience and the satisfaction of the user. However, the flow rate of the liquid passing through the filter element is decreased when a size of the pore(s) is decreased.

In an embodiment, the filter element can be provided with a plurality of filtering pores.

Thereby, the flow rate of introduction of a liquid into the receptacle may be maximised, and flow rate of the mixed product out of the receptacle may be maximised.

In an embodiment, said body can define a first end, a second end opposite said first end and a centre section arranged in between said first and second ends relative to a longitudinal axis of said body, where the cross-sectional area of said body perpendicular to said longitudinal axis is smaller at said centre section than at said first and second ends.

Providing a centre section of a smaller cross-sectional area than at the first and second ends results in that turbulence is created in the liquid and the powder when mixed by shaking the receptacle, which turbulence improves the mixing. Thus, the improved mixing takes place as the liquid and powder are forced to move back and forth between the first and second ends via the centre section, according to Newton's third law, when the receptacle is shaken along the direction of the longitudinal axis of the receptacle. The movement of the liquid and powder via the centre section forces the liquid to swirl, thereby creating turbulence, which improves the mixing.

Further, by providing a centre section of a smaller cross-sectional area than at the first and second ends, a natural grip of the receptacle for a human hand is achieved, improving the manageability of the receptacle.

In an embodiment, the edge of said body at said centre section can at least partly bend towards the inner volume of said body. The shape of the edge of said body at said centre section may be, but is not limited to, circular, tooth-shaped, triangular, or rectangular.

Thereby, the design of the receptacle may be changed depending on needs and wishes. Further, the size and shape of the edges of said body at said centre section may be altered for increasing or decreasing the mixing capabilities of the receptacle. E.g. the edges of said body at said centre section may be of a size and shape so that the cross-sectional area of the receptacle is reduced thereby forcing the liquid and powder to move into a narrow swirl channel and increasing the turbulence of the liquid and powder, when the receptacle is shaken.

In an embodiment, said body can comprise a flexible, liquid impermeable plastic material such as polyethylene (PE), polyethylene terephthalate (PET), or polypropylene (PP), or combinations thereof. Biodegradable plastics are foreseen within the scope of the invention as well.

Thereby, the receptacle is flexible, which is advantageous during storing and transport, and the receptacle is further ensured to be leak-tight. By using biodegradable plastics, the environmental impact of the receptacle is minimised.

In an embodiment, said body can be formed by at least one sheet made from a flexible, liquid impermeable material, wherein at least a part of the edge of said sheet is joined, such that said sheet defines the inner volume of said body.

Thereby, the body may be formed from a single sheet. The shape of the sheet may be designed such that the body, comprising an inner volume, is formed when the single sheet is bended and joined along at least part of the edge of the sheet. For example, a bottom edge of the body may comprise a straight edge, which simplifies the bending of the sheet along this edge. In this case, the bottom edge serves as a mirror line, with substantially identical parts of the sheet being arranged on either side of said mirror line. The conduit may be arranged along a top edge, most distant from the bottom edge.

In an embodiment, the conduit and the filter element can be shaped in one piece.

Thereby, no means for attachment of the filter element onto the second open end of the conduit is needed, increasing the strength of the combined conduit and filter element. Further, by the conduit and filter element being shaped in one piece, the fabrication of the receptacle is simplified. E.g. the combined conduit and filter element may be casted in a single process. The combined filter element and conduit may preferably be made from the same material. The material is preferably a rigid plastic material.

In an embodiment, a mixing mesh can be arranged in said inner volume of the body, said mixing mesh comprising a flexible material.

Thereby, improved mixing capabilities are achieved. The mixing mesh is most preferably arranged within the centre section. The mixing mesh is most preferably made from a flexible plastic material, such that the presence of the mixing mesh does not affect e.g. the durability, or the transportation or storing capabilities of the receptacle. The mixing mesh may be fixed to said body. The mixing mesh does not restrict fluid communication between the first and second end of the body; rather said mixing mesh is most preferably arranged such that fluid communication is provided partly through said mixing mesh, partly bypassing said mixing mesh. During handling and shaking of the receptacle, the mixing mesh is likely to wave and bend, thereby increasing the fluid communication of the liquid and powder through the mixing mesh. Thus, when shaking the receptacle comprising a consumable liquid and a consumable powder, the fluid communication through the mixing mesh increases the mixing capabilities of the receptacle.

In an embodiment, said body can comprise a first and a second sheet made from a flexible, liquid impermeable material, wherein at least a part of the edges of said sheets are joined, such that said sheets define the inner volume of said body. Providing a first and a second sheet simplifies the production of said body, as the sheets only have to be put on top of each other and be joined e.g. by use of heat and/or pressure in a welding process.

### LIST OF FIGURES

FIG. 1 shows an embodiment of the receptacle of the present invention in a cross-sectional view.

FIG. 2 shows a side view of an embodiment of the filter element.

FIG. 3 shows a perspective view of an embodiment of the filter element according to FIG. 2.

FIG. 4 shows a side view of an embodiment of the filter element.

FIG. 5 shows a side view of an embodiment of the filter element.

FIG. 6 shows an embodiment of the present invention in a cross-sectional view comprising a mixing mesh.

FIG. 7 shows a technique to form a body from a single sheet of a flexible, liquid impermeable material.

### DESCRIPTION OF DRAWINGS

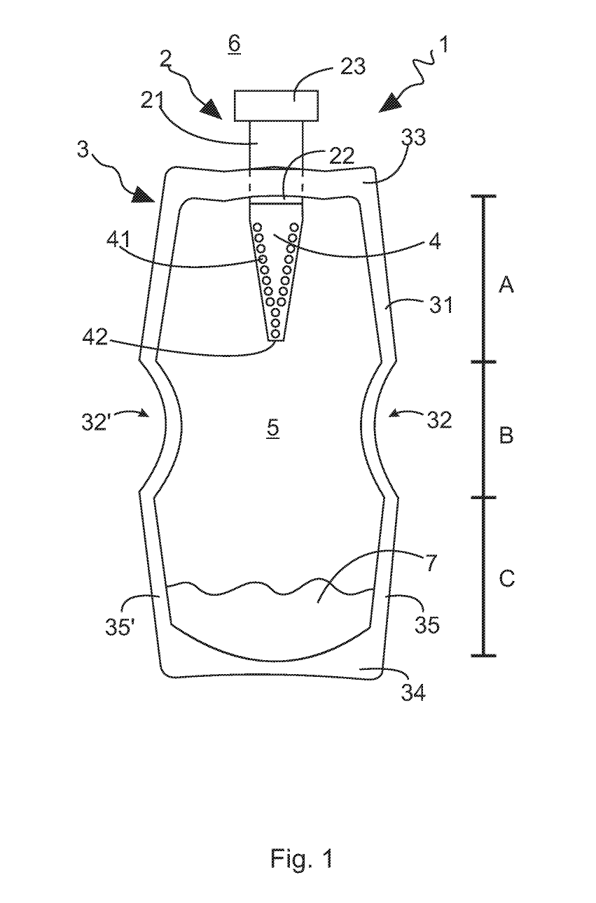

FIG. 1 shows an embodiment of the receptacle of the present invention in a cross-sectional view. The receptacle 1 comprises a conduit 2, a body 3, and a filter element 4. The conduit 2 provides fluid communication between the outside 6 and an inner volume 5 of said body 3. Said body 3 comprises a flexible material and is of a type that is at least adapted to be collapsible when containing the powder and to be expandable when receiving the liquid. Said body may comprise two sheets of a flexible and liquid impermeable material, said sheets being joined along their edges 31, thereby encapsulating and defining the inner volume 5. The inner volume 5 may comprise a consumable powder 7.

The conduit 2 comprises at least two ends; a first open end 21, and a second open end 22, where said first open end 21 protrudes outwards from the body and is in contact with the outside 6, and said second open end 22 protrudes into the inner volume 5 of said body 3. The first open end 21 is releasably connected to a closing member 23 for reversibly blocking access through the first open end 21 and therefore for blocking a flow between the first open end 21 and the second open end 22.

The joined edges 31 of the body 3, which may be formed by first and second sheets, define a first end 33, a second end 34, and a centre section comprising edges 32, 32′. Side edges 35, 35′ of the body stretch from said first end 33 to said second end 34. Further, the inner volume 5 comprises a first chamber A partially defined by the first end 33, a second chamber C partially defined by the second end 34, and a centre chamber B in between the first chamber A and the second chamber C, said centre chamber B being partially defined by the edges 32, 32′ of the centre section. The centre chamber B is characterised in that its edges 32, 32′ may comprise depressions in a direction towards each other, as said edges 32, 32′ may at least partly bend towards the inner volume of said body 3. Said depressions and/or edges 32, 32′ restrict laminar flow between said two chambers A, C, when the consumable liquid is forced to move from one chamber to the other, e.g. due to shaking of the receptacle 1 and thereby Newton's third law.

The filter element 4 may be connected to the second open end 22 of the conduit 2, and protrudes into the inner volume 5 of the body 3. The filter element 4 may comprise at least one filtering pore 41. The vertex 42 of the filter element 4 is depicted in a truncated case; in this case, the vertex 42 may be either open or closed, depending on the needed amount of fluid communication between the inner volume 5 and the outside 6 of the body 3.

A liquid is added to the inner volume 5 of the body 3 through the conduit 2 and filter element 4. Within said inner volume 5, said liquid partly dissolves the powder 7, and by shaking the receptacle 1, an improved mix between said liquid and powder is achieved. The turbulence induced by the centre chamber B ensures improved mixing capabilities of the receptacle 1. When the depressions and/or edges 32, 32′ of the centre chamber B have a curved shape, a natural grip for a hand is obtained.

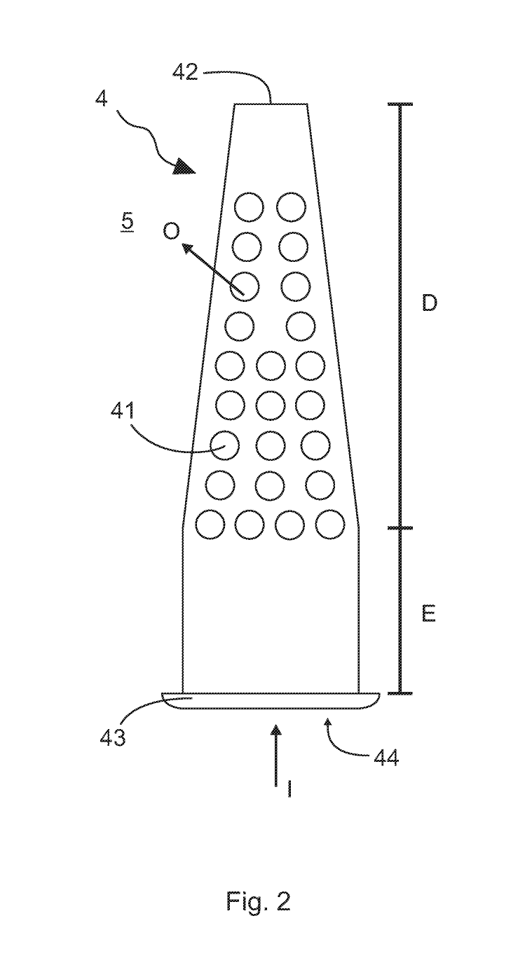

FIG. 2 shows a side view of an embodiment of the filter element 4. In this embodiment, the filter element 4 comprises a conically shaped portion D, and a cylindrical portion E. A flange 43 may be provided along an open base 44 of the filter element 4. The flange 43 may be used in certain attachment configurations for connecting the filter element 4 to the second open end 22 of the conduit 2. The vertex 42 of the conically shaped portion D may be truncated as depicted in this embodiment, or it may be a single point. The truncated vertex 42 may be either open or closed. The surface of the conically shaped portion D comprises at least one pore 41, but most preferably, a plurality of pores 41 are provided. The pores 41 in combination with an open truncated vertex 42 provide fluid communication between the open base 44 and the inner volume 5 of the body 3, as indicated by the input flow arrow I, and the output flow arrow O. The reverse flows take place, when the mixed liquid and powder leaves the receptacle, i.e. when the user drinks the mixed liquid and powder. The cylindrical portion E is illustrated as not provided with pores 41 for creating a distance between the second open end 22 of the conduit 2 and the pores 41. This may be beneficial as, in a case where the receptacle 1 by accident is turned upside down without a closing member, the powder does not escape the receptacle.

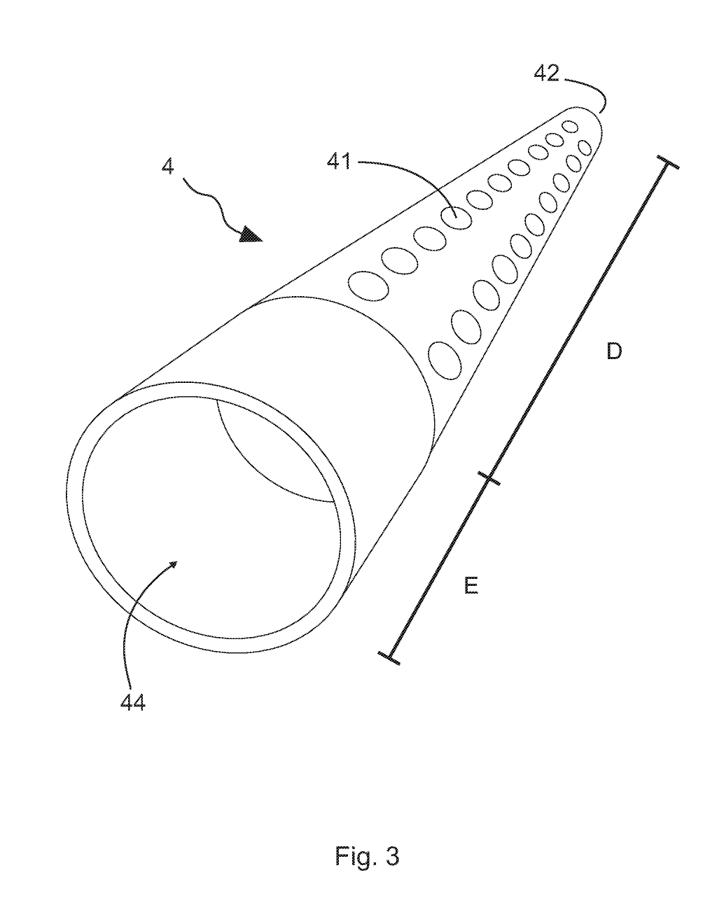

FIG. 3 shows a perspective view of a filter element 4 according to FIG. 2, depicted without a flange. For similar parts, similar reference numbers have been used as in FIG. 2.

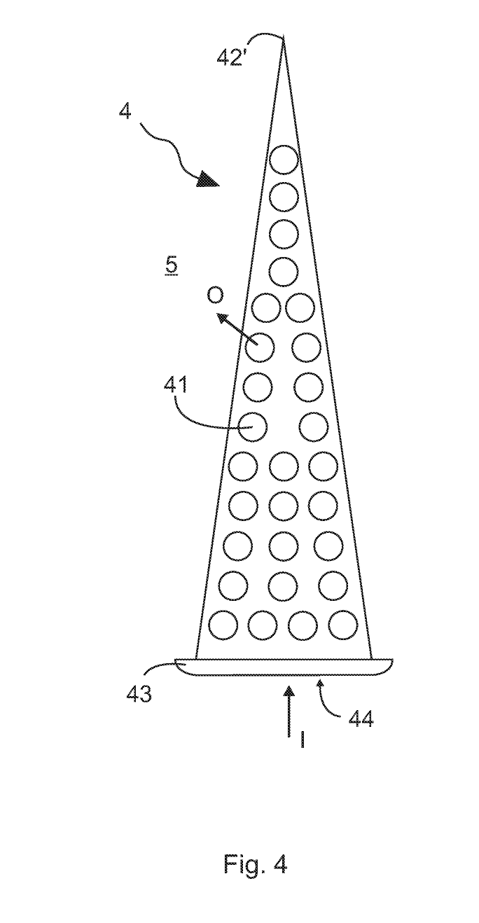

FIG. 4 shows a side view of another embodiment of the filter element 4. For similar parts, similar reference numbers have been used as in FIG. 2. In this embodiment, the filter element 4 solely comprises a conically shaped portion. The vertex 42′ is depicted as a single point, but may instead be truncated as in FIG. 2. The filter element 4 may be used without a flange 43.

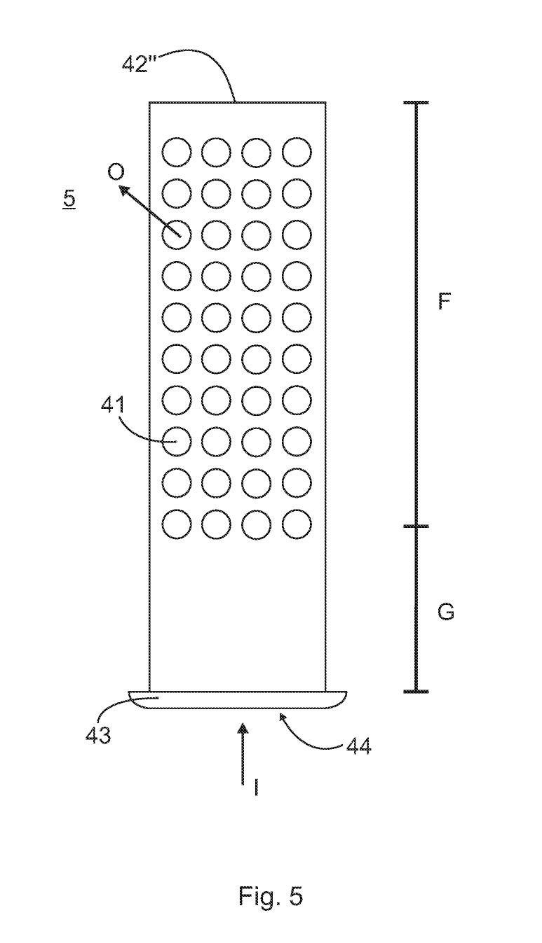

FIG. 5 shows a side view of another embodiment of the filter element 4. For similar parts, similar reference numbers have been used as in FIG. 2. The filter element 4 is solely cylindrically shaped, with a pore-free portion G and a pore 41 portion F. The top end 42″ may be either open or closed.

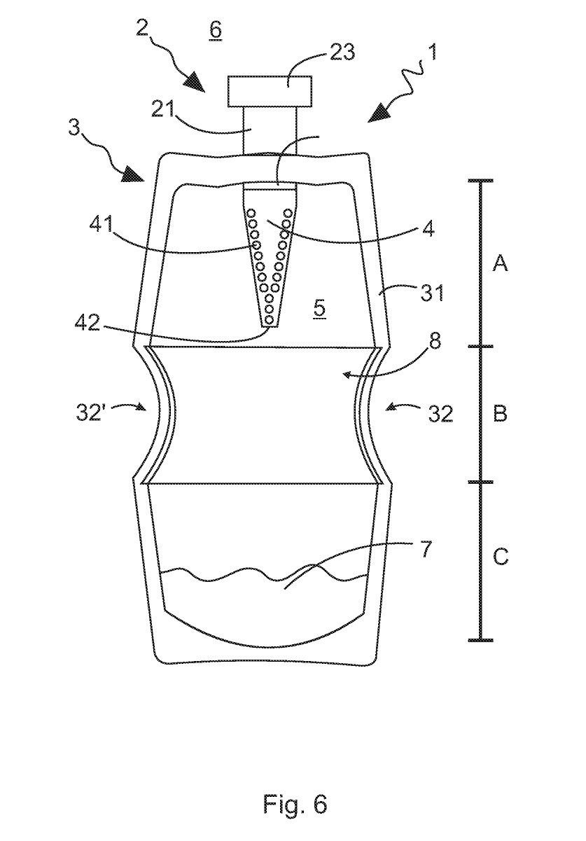

FIG. 6 shows a cross-sectional side view of an embodiment of the receptacle 1 according to FIG. 1. For similar parts, similar reference numbers have been used as in FIG. 1. A mixing mesh 8 is provided within the inner volume 5 of the body 3, and may be fixed to the body 3. Most preferably, the mixing mesh 8 is arranged within the centre chamber B and joined to the joined edges 31 of the body 3. The mixing mesh 8 does not restrict fluid flow between the second chamber C and the first chamber A, rather said mixing mesh 8 is most preferably arranged such that fluid flow is provided partly through said mixing mesh 8, and partly bypassing said mixing mesh 8.

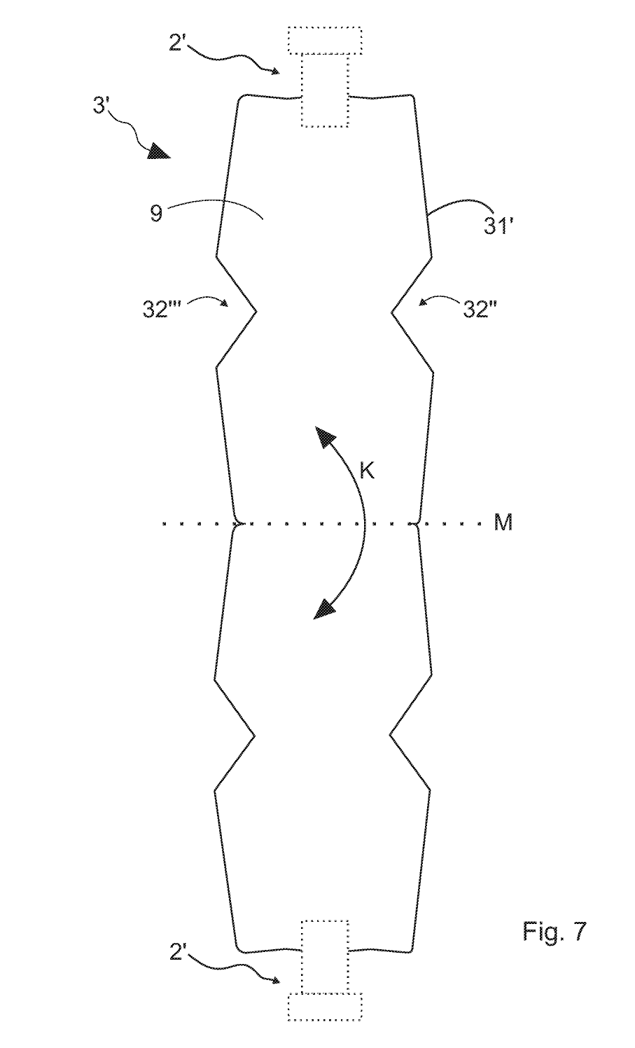

FIG. 7 shows a conceptual side view of a way to realize a body 3′ from a single sheet 9 of a flexible, liquid impermeable material. The sheet 9 is mirrored along the line M, and the body 3′ is formed by bending the sheet 9 along said line M, as indicated by the arrow K. Once bended, parts of the edges 31′ are joined to form an inner volume of the body 3′. An outline of a conduit 2′ is provided for clarity. The depressions, 32″ and 32′″, are depicted as triangular in this embodiment, but other shapes are foreseen as well, as disclosed previously.

1. A receptacle for containing a powder and for mixing the powder with a liquid into a mixed product, the receptacle comprising:
a body at least partly comprising a flexible material, the body being of a type that is at least adapted to be collapsible when containing the powder and to be expandable when receiving the liquid,
a conduit being connected to the body and comprising a first and a second open end, where the first open end is arranged outside the body and the second open end is arranged in the inner volume of the body so that the conduit provides fluid communication between the outside and the inner volume of the body, and where the first open end is releasably connected to a closing member for blocking access through the first open end,
wherein
the receptacle further comprises a filter element adapted to be connected to the second open end of the conduit.

2. A receptacle according to claim 1, wherein the filter element is adapted to be releasably connected to the second open end of the conduit.

3. A receptacle according to claim 1, wherein the filter element is adapted to be connected to the second open end of the conduit by being adapted to be inserted through the first open end and moved to the second open end of the conduit.

4. A receptacle according to claim 1, wherein the filter element and/or the conduit comprise a rigid material.

5. A receptacle according to claim 1, wherein the filter element comprises an elongated shape.

6. A receptacle according to claim 1, wherein the filter element comprises a hollow structure.

7. A receptacle according to claim 6, wherein the hollow structure of the filter element is at least partly conically shaped.

8. A receptacle according to claim 1, wherein the filter element comprises a ring base for attachment to the second open end of the conduit.

9. A receptacle according to claim 1, wherein the filter element comprises at least one filtering pore, thereby providing fluid communication between the outside and the inner volume of the body, when the filter element is attached to the second open end of the conduit.

10. A receptacle according to claim 1, wherein the filter element comprises at least a first and a second filtering pore, where the first filtering pore is arranged closer than the second filtering pore to the second open end of the conduit, when the filter element is connected to the second open end, and where the diameter of the first filtering pore is less than the diameter of the second filtering pore.

11. A receptacle according to claim 1, wherein the filter element comprises a vertex being either truncated or pointed.

12. A receptacle according to claim 1, wherein the filter element forms part of the conduit, such that the conduit extends from the first open end to the second open end comprising the filter element.

13. A receptacle according to claim 1, wherein the body defines a first end, a second end opposite the first end and a centre section arranged in between the first and second ends relative to a longitudinal axis of the body, where the cross-sectional area of the body perpendicular to the longitudinal axis is smaller at the centre section than at the first and second ends.

14. A receptacle according to claim 1, wherein the body comprises a flexible, liquid impermeable plastic material such as polyethylene, polyethylene terephthalate, or polypropylene, or combinations thereof.

15. A receptacle according to claim 1, wherein a mixing mesh is arranged in the inner volume of the body, the mixing mesh comprising a flexible material.

16. A receptacle according to claim 1, wherein the body is formed by at least one sheet made from a flexible, liquid impermeable material, wherein at least a part of the edge of the sheet is joined, such that the sheet defines the inner volume of the body.

17. A receptacle according to claim 1, wherein the body comprises a first and a second sheet made from a flexible, liquid impermeable material, wherein at least a part of the edges of the sheets are joined, such that the sheets define the inner volume of the body.
